(19) United States
(12) Patent Application Publication
(10) Pub. No.: US 2023/0343972 A1
(43) Pub. Date: Oct. 26, 2023

(54) SEPARATOR PLATE AND ARRANGEMENT FOR AN ELECTROCHEMICAL SYSTEM, AND ELECTROCHEMICAL SYSTEM

(71) Applicant: Reinz-Dichtungs-GmbH, Neu-Ulm (DE)

(72) Inventors: Kurt HOEHE, Bussmanshausen (DE); Stephan WENZEL, Ulm (DE); Christoph SPECHT, Pfaffenhofen (DE); Bernd GAUGLER, Langenau (DE); André SPEIDEL, Neu-Ulm (DE); Franz SCHWEIGGART, Neu-Ulm (DE)

(21) Appl. No.: 18/306,120

(22) Filed: Apr. 24, 2023

(30) Foreign Application Priority Data
Apr. 25, 2022 (DE) 20 2022 102 212.7

(51) Int. Cl. H01M 8/0263; H01M 8/0286; H01M 8/0267; H01M 8/1004; C25B 13/02; C25B 9/19

(52) U.S. Cl. CPC H01M 8/0263; H01M 8/0286; H01M 8/0267; H01M 8/1004; C25B 13/02; C25B 9/19

(57) ABSTRACT

Electrochemical systems, separator plates and methods for production thereof, the separator plate comprising: an active region and at least one first through-opening for supplying a reaction medium to flow channels, and one second through-opening for conducting the reaction medium away from flow channels. At least one through-opening enclosed by a roller-embossed sealing bead. Roller embossing a first layer in a first transportation direction and roller embossing a second layer in a second transportation direction, and arranging the two metal layers opposite one another relative to the respective transportation directions. Two roller-embossed sealing beads are arranged one above the other.

### CROSS-REFERENCE TO RELATED APPLICATION

The present application claims priority to German Utility Model Application No. 20 2022 102 212.7, entitled “SEPARATOR PLATE AND ARRANGEMENT FOR AN ELECTROCHEMICAL SYSTEM, AND ELECTROCHEMICAL SYSTEM”, filed Apr. 25, 2022. The entire contents of the above-listed application is hereby incorporated by reference for all purposes.

### TECHNICAL FIELD

The present disclosure relates to a separator plate and to an arrangement for an electrochemical system, for example for a fuel cell or an electrolyzer. Separator plates of this kind are also referred to as bipolar plates and are typically connected in the form of a stack of separator plates and cells or membrane electrode assemblies to create an electrochemical system. The arrangements for an electrochemical system have single-layer or multi-layer separator plates and membrane electrode assemblies. The present disclosure also relates to an electrochemical system comprising separator plates of this kind. By way of example, the electrochemical system may be a fuel cell system, an electrochemical compressor, a redox flow battery or an electrolyzer.

### BACKGROUND AND SUMMARY

Separator plates of this kind usually have structures used for supplying one or more media and/or for carrying reaction products away.

For instance, separator plates of this kind have an active region comprising flow channels for reaction media along their outer faces. In addition, separator plates of this kind have through-openings for supplying reaction media to the active region. These through-openings and the active region can be interconnected by means of further structures, for example so-called distribution and/or collection regions comprising channels for conducting a reaction medium from a through-opening to the channels of an active region and vice versa.

Typically, separator plates of this kind have two metal layers—a first metal layer and a second metal layer arranged adjacent thereto—which are interconnected, for example welded. For some applications, however, single-layer separator plates may be selected.

By way of example, the individual layers of the separator plate are provided with the aforementioned structures by means of embossing, such as vertical embossing and/or roller embossing. When the planar dimensions of the individual layers are not too big, the layers can undergo vertical embossing. As the size of the individual layer increases, so too do the forces needed for the vertical embossing of that layer, meaning that the vertical embossing of the layer becomes increasingly difficult and is no longer possible using available presses above certain dimensions, which in turn depend on the thickness and deformability of the sheet. Moreover, the process times required for the vertical embossing of large quantities, such as large quantities of big plates, are unreasonable, or a multiplicity of presses are needed, which is not economically viable.

As an alternative, the prior art, for example DE 10 2004 016 318 A, already discloses roller embossing for shaping channel structures between each of which the same medium, which may also pass over into other channel structures, is conducted. In separator plates of this kind partially produced using roller embossing, the sealing is achieved by means of separate elements, for example mounted or molded on elastomer profiles. The advantage of roller embossing is that the contact surfaces, which are reshaped all at once, are significantly smaller than with vertical embossing for the same die width and thus require less force to be applied.

However, the drawback of roller embossing compared with vertical embossing is that the structures generated by means of a single roller embossing have lower dimensional accuracy when using the currently known and available technology. Therefore, roller embossing is used only in areas that need low embossing accuracy. To produce a component, it is also possible to combine roller embossing and vertical embossing. In principle, however, sufficiently precise shaping may be achieved in just one production step.

In terms of reliable sealing and also the reliable passage of reaction media from through-openings to an active region of a separator plate, it has been found that embossed sealing beads are considerably superior to elastomer profiles mounted or placed on as sealing elements. The same applies to the sealing of all fluid conducting regions of a separator plate with respect to the surroundings; in this case, the sealing beads used therein can also be referred to as peripheral beads.

However, to obtain a reliable sealing action, sealing beads of this kind require very high accuracy in the embossed structures, so roller embossing methods have so far not been an option in this area for embossing sealing beads. This is because when a recess is roller-embossed, the flank angles of the recess, e.g. the entry angle and exit angle, vary due to the rolling direction and thus the embossing direction of the layer through the roller embossing die. To make the rigidity of beads even, for example to achieve optimal and uniform spring behavior, several measures have been taken, for example using wave-shaped beads that, over elongate beads, have a similar rigidity to their corner regions; see DE 102 48 531 A1 or special forms of such a wave shape as disclosed, for example, in DE 20 2014 008 375 U1. This shows that very high precision is required both during design and when shaping the sealing beads in practice. Even if the variability in the flank angles appears to be low, the rigidity of a sealing bead can be considerably impaired by varying flank angles of the bead flanks thereof, and the beads may be prone to tipping. For this reason, no roller-embossed separator plates having embossed sealing beads are currently available.

An alternative option is to adjust the die when configuring the die for a roller embossing method such that the separator plates embossed thereby are shaped uniformly despite the anisotropy of the roller embossing. However, this requires a complex, for example multi-step, design process for the die, thus making the embossing dies much more expensive.

The problem thus arises that, first, vertical embossing methods reach their limits when the layers of a separator plate are very large, and second, when these layers also have sealing beads, roller embossing methods currently result in said sealing beads providing insufficient sealing.

Against this background, the object of the present disclosure is to make available a separator plate and an electrochemical system comprising such separator plates, which can be produced in a less burdensome manner, such as using smaller forces, while meeting the high demands placed on the sealing action of the sealing beads embossed using roller embossing. Advantageous developments of the separator plate according to the present disclosure, the arrangement according to the present disclosure and the electrochemical system according to the present disclosure are provided in the dependent claims.

In a first variant, the separator plate according to the present disclosure is a separator plate for an electrochemical system, for example a fuel cell, an electrochemical compressor, a redox flow battery or an electrolyzer. For electrolyzers, but also for fuel cells more recently, the problem arises that the individual layers of a separator plate according to the present disclosure have a large planar extension and thus are difficult to mold using vertical embossing.

The separator plate according to the present disclosure now has a first metal layer and a second metal layer, for example an anode plate and a cathode plate. The two metal layers are arranged adjacent to one another and one above the other. In systems that require cooling, a coolant can be conducted between these two metal layers. In electrolyzers, for example, this is often not required for process reasons, but the two-layer construction may also be advantageous in this case so that the structures of the anode plate and cathode plate can be configured independently of one another.

According to the present disclosure, the individual layers have an active region, which in each case has a set of embossed flow channels for a reaction medium, which each extend on the outer face of the separator plate along each metal layer. In addition, each of the layers has a first through-opening for supplying a reaction medium to the active region. Further portions can be arranged between the first through-opening and the active region, and the reaction medium flows via said portions on its way from the first through-opening to the active region. For example, it is possible to have distribution regions comprising distribution channels via which the reaction medium fed in through the first through-opening is distributed and uniformly fed to the channels of the active region. On the other side of the separator plate, drainage can be achieved by means of a collection region.

In each of the metal layers, the first through-opening is enclosed by a sealing bead. In an electrochemical system in which a multiplicity of separator plates and membrane electrode assemblies are arranged alternately in the form of a stack, said sealing bead seals the series of through-openings, extending through the stack, in separator plates and membrane electrode assemblies in the region of the reinforcement edge of the membrane electrode assembly towards the space surrounding the sealing bead.

Sealing beads of this kind extend, for example, around one, several or each of the through-openings. For sealing with respect to the surroundings of the plate, a similar sealing bead can extend in an integrally closed manner in the layer in the form of a so-called peripheral bead at a distance from and along the circumferential edge of the layer in question. A peripheral bead seals the gap between adjacent separator plates and membrane electrode assemblies or the reinforcement edge thereof in a stack of an electrochemical system with respect to the surroundings of the stack.

As well as a first through-opening for supplying a reaction medium to the active region, the metal layers of the separator plate also have a second through-opening for conducting the reaction medium or reaction products out of the active region. In turn, further guide structures, for example flow channels, may extend between the active region and the second through-opening in a collection region, said guide structures collecting the reaction medium or reaction products from the active region and conducting them to the second through-opening. In the same way as with the first through-opening, the second through-opening may be enclosed by a sealing bead.

In this context, it is already known from the prior art that the metal layers of an electrochemical system can be roller-embossed at least in some portions; however, they are used in combination with other sealing systems, for example with molded-on or placed-on elastomer sealing profiles.

In the present disclosure, however, at least one of the aforementioned sealing beads, but possibly even several or all of the aforementioned sealing beads, are now made in each layer using roller embossing. In this process, the roller embossing of the first layer and the second layer, which is disadvantageous per se for sealing beads, is now carried out such that the two metal layers of the separator plate are arranged the opposite way to one another in terms of their transportation directions during the roller embossing in order to produce the separator plate.

By arranging the two metal layers of a separator plate the opposite way to one another, which metal layers are roller-embossed at least in the regions of one of their sealing beads, said sealing beads, which are arranged one on the other in the separator plate, are now arranged such that the one sealing bead of the first layer has the entry angle, generated during roller embossing, where the sealing bead of the second layer has the exit angle generated by the roller embossing. Accordingly, the exit angle of a sealing bead of the first metal layer is combined with the entry angle of a sealing bead of the second metal layer. In this case, it has been found that arranging the metal layers of a separator plate in this way makes the sealing beads less prone to tipping and leads to more balanced compression behavior of the electrochemical system and thus to considerably improved tightness of the sealing by the adjacent sealing beads of the first and the second metal layer as well as in the electrochemical system.

Advantageously, one, several or all of the roller-embossed sealing beads of the first metal layer and the second metal layer can be provided with an elastomer-based, possibly foamed, coat at least partly or even in their entirety, in order to improve the microsealing of the sealing beads. Alternatively, a coat of this kind can also be mounted on the surface, adjoining the sealing bead, of the reinforcement edge of the membrane electrode assembly.

One, several or all of the roller-embossed beads of the first and/or the second metal layer can be formed as full beads. Full beads have a bead top and bead bottoms adjacent to the bead top on both sides in cross section through the bead, a bead flank extending between the bead top and each of the bead bottoms. If beads of this kind are coated to improve their microsealing, it is sufficient to apply, e.g. imprint, spray or mold on, an elastomer-based coat solely on the bead top thereof, where applicable at least on a portion of the bead top in the width direction of the bead top.

Different orientations are possible for the sealing beads according to the present disclosure. Firstly, the roller-embossed beads of the first and the second layer, which are arranged one above the other in a plan view of the separator plate, face one another by their bead tops. This means that in the case of adjacent separator plates in a stack of an electrochemical system, the adjacent sealing beads of adjacent separator plates are indirectly adjacent to one another by their bead bottoms, with the reinforcement edge of the membrane electrode assembly therebetween. Alternatively, the roller-embossed beads of adjacent metal layers of the same separator plate may be arranged so as to face away from one another by their bead tops. In this case, adjacent beads of two adjacent separator plates in a stack of an electrochemical system are arranged indirectly adjacent to one another or one on the other by their bead tops, with the reinforcement edge of the membrane electrode assembly therebetween.

When viewing the bead in cross section, the bead tops of the full beads need not necessarily extend in a straight line but may also be curved, for example have a recess in the middle. An elastomer filler may be arranged in a middle recess of this kind, for example an injected or molded-on filler. In a first embodiment, this elastomer filler may be formed such that it protrudes beyond the bead top, e.g. such that in the non-compressed state it has a greater height than the two bead top portions adjacent thereto on either side in cross section. In an alternative embodiment, however, the elastomer filler may also have a similar height to the adjacent bead top portions. In both cases, a bead filled in this way has different spring stiffnesses depending on its degree of compression. It is also possible for the curvature of the bead top to point away from the bead bottoms.

By arranging the first metal layer and the second metal layer in the separator plate according to the present disclosure the opposite way to one another in terms of the roller embossing direction or transportation direction, portions of the roller-embossed bead of the first layer and of the roller-embossed bead of the second layer that are arranged one above the other at least in some portions in a vertical plan view of the separator plate have bead flanks of different flank angles arranged one above the other, or the flank angles are different on either side of a sealing bead in a cross section through the sealing bead. The differences in terms of the flank angles need not be large; in practice, the flank angles mostly differ by less than 5°, in many cases by less than 2.5°, or by less than 1.5°.

The different transportation direction during the roller embossing is apparent not only from the different entry and exit angles of the bead flanks, but also from anisotropic structure changes of the sealing beads reshaped by means of roller embossing.

In both cases, the sealing beads of the first and the second layer, which sealing beads are arranged one above the other, can have a substantially point-symmetrical formation in terms of their bead flanks in cross section through the separator plate.

In regions in which one or more of the sealing beads have breaks in one or more of the bead flanks, for example openings in the relevant metal layer, or in regions in which the sealing bead has a sideways extension, a bulge or further branching embossed structures, each sealing bead lacks the above described bead flank over a substantial region of its extension from bead top to bead bottom, so no conclusion can be drawn regarding the relevant flank angle. In addition, the spring behavior of the bead is dominated by said elements that break up the bead flank, and so only those regions of a bead course in both layers of a separator plate in which none of the two beads, e.g. neither the bead of the first layer nor the bead of the second layer, has such a break are considered in terms of complementary flank angles.

Advantageously, the first layer and/or the second layer is/are structured entirely by roller embossing. In this case, it is advantageous if the transportation direction during roller embossing extends substantially or exactly perpendicularly to or substantially or exactly in parallel with the longitudinal extension of at least some of the flow channels for the reaction medium in the active region. In this case, ‘substantially’ includes deviations of ±10°, ±5° and ±3° from a perpendicular to the longitudinal extension or from a parallel to the longitudinal extension.

Since the flow channels can extend lengthwise not only in a straight line but also in a wave-shaped, zigzag or meandering manner or in any other form, the rolling direction in these cases is based on an average extension direction of the flow channels in the active region. However, it is also possible for the transportation direction to be provided at any other angle to the average extension direction of the flow channels in the active region.

The aforementioned sealing beads are formed as circumferential, integrally closed sealing beads. They may have regions in which the beads extend in parallel with or in the opposite direction to the transportation direction and thus may have no significant differences in their compression behavior or flank tilt between the two layers. Arranging the first layer and the second layer the opposite way to one another is thus effective for the compression behavior only in corresponding portions of the relevant sealing beads that extend partly, largely or entirely transversely to the transportation direction.

In one variant, the present disclosure relates to an arrangement for an electrochemical system comprising a first separator plate and a second separator plate, in which a membrane electrode assembly is arranged between the two separator plates. Said separator plates each have a first metal layer and a second metal layer arranged adjacent to the first metal layer vertically in relation to the layer plane. In the process, in each of said separator plates there is formed an active region, having in each case at least one set of embossed flow channels for a reaction medium along each outer face of the separator plate, as well as at least one first through-opening for supplying a reaction medium to one of the sets of flow channels and one second through-opening for conducting the reaction medium away from the set of flow channels. In addition, in each of the two separator plates, at least the first through-opening in each of the metal layers, or the second through-opening in each of the metal layers, is enclosed and sealed by a roller-embossed sealing bead. In the mutually facing layers of the first and the second separator plate, said roller-embossed sealing beads are arranged one above the other in the vertical direction in relation to the extension plane of the membrane electrode assembly. To homogenize the elasticity of the sealing elements, the roller-embossed sealing beads in the mutually facing layers of the first and the second separator plate are arranged such as to have different orientations. In this case, the first of these layers is roller-embossed in a first transportation direction and the second of these layers is roller-embossed in a second transportation direction, the two metal layers being arranged the opposite way to one another in terms of their transportation directions.

In the process, the first variant can be combined with this variant such that all the layers of the two-layer separator plates have roller-embossed sealing beads in which the sealing beads, which come to rest one above the other either directly or with a reinforcement edge of a membrane electrode assembly therebetween, each have different transportation directions.

In addition to the aforementioned separator plates having two metal layers, in some electrochemical systems, such as in electrochemical systems cooled by means of the reaction media, there are also arrangements in which just one single-layer separator plate is arranged between the closest membranes in each case. The description above in relation to two-layer separator plates, in so far as it also relates to just one metal layer, also applies to single-layer separator plates. In a system of this kind, the sealing elements of the now single-layer separator plates can also be molded into the plate as beads by means of roller embossing. This results in another variant of the present disclosure. It is also possible for two closest cells within a stack to be separated by a two-layer separator plate while another pair of closest cells is separated by a single-layer separator plate.

A corresponding variant accordingly comprises an arrangement for an electrochemical system comprising a first separator plate and a second separator plate, between which a membrane electrode assembly is arranged. At least one of said separator plates, but both separator plates, may have precisely one metal layer. In each of said two separator plates there is formed an active region, having in each case at least one set of embossed flow channels for a reaction medium along each outer face of the separator plate, as well as at least one first through-opening for supplying a reaction medium to one of the sets of flow channels and one second through-opening for conducting the reaction medium away from the set of flow channels. In addition, in each of the two separator plates, at least the first through-opening is enclosed by a roller-embossed sealing bead. Like in the second variant, the roller-embossed sealing beads in the first and the second separator plate, where applicable in the closest layers of the first and the second separator plate, are arranged one above the other in the vertical direction in relation to the extension plane of the membrane electrode assembly. Like in the two preceding variants, the roller-embossed sealing beads in the first and the second separator plate have different orientations. In this case, the first separator plate is roller-embossed in a first transportation direction and the second separator plate is roller-embossed in a second transportation direction, and said two separator plates are arranged the opposite way to one another in terms of their transportation directions.

The present disclosure also relates to a method for producing a separator plate or an electrochemical system as described above, at least the embossed sealing beads in the first layer and in the second layer being formed by roller embossing. In this case, the first layer is roller-embossed in a first transportation direction and the second layer is roller-embossed in a second transportation direction. In the process, to form the separator plate, the first and the second layer are arranged the opposite way to one another in terms of their transportation directions and interconnected.

Examples of separator plates according to the present disclosure will be given below. In this context, identical and similar elements of the separator plates are given identical or similar reference numerals, so the description thereof is not always repeated. The following examples set out the features according to the present disclosure together with one or more optional enhancements and developments according to the present disclosure. However, it is also possible to use individual elements of these enhancements and developments independently of the further elements of the examples, or even in combination with some of the further elements of the same example or of other examples, and to enhance the present disclosure further as a result.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIGS. 1 and 2 show an electrochemical system according to the present disclosure.

FIG. 3 is a cross section through a known electrochemical system.

FIG. 4 is a schematic illustration, in three sub-figures 4A, 4B and 4C, of a production method for the separator plates according to the present disclosure and, in a further sub-figure 4D, a cross section through a portion of a metal layer of an electrochemical system according to the present disclosure.

FIGS. 5A to 10B show cross sections through portions of electrochemical systems according to the present disclosure.

### DETAILED DESCRIPTION

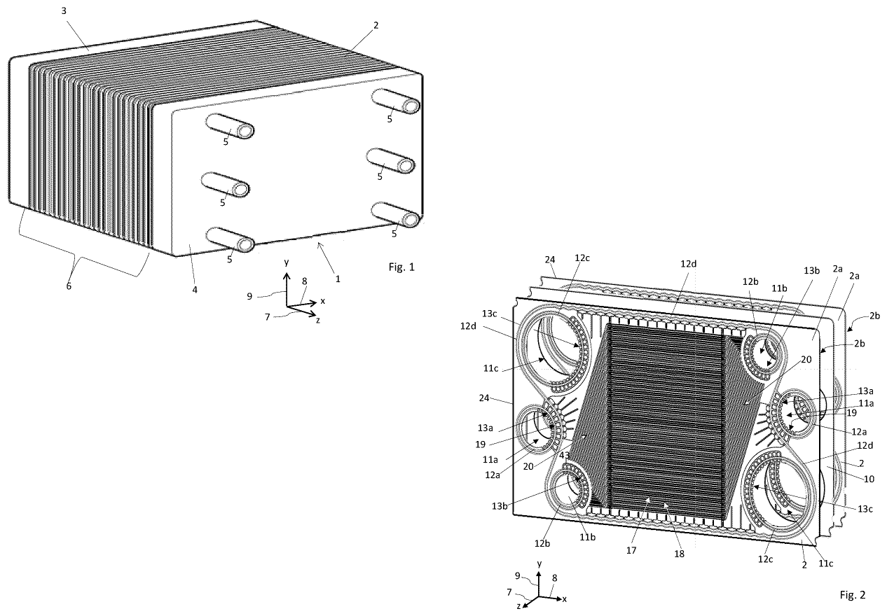

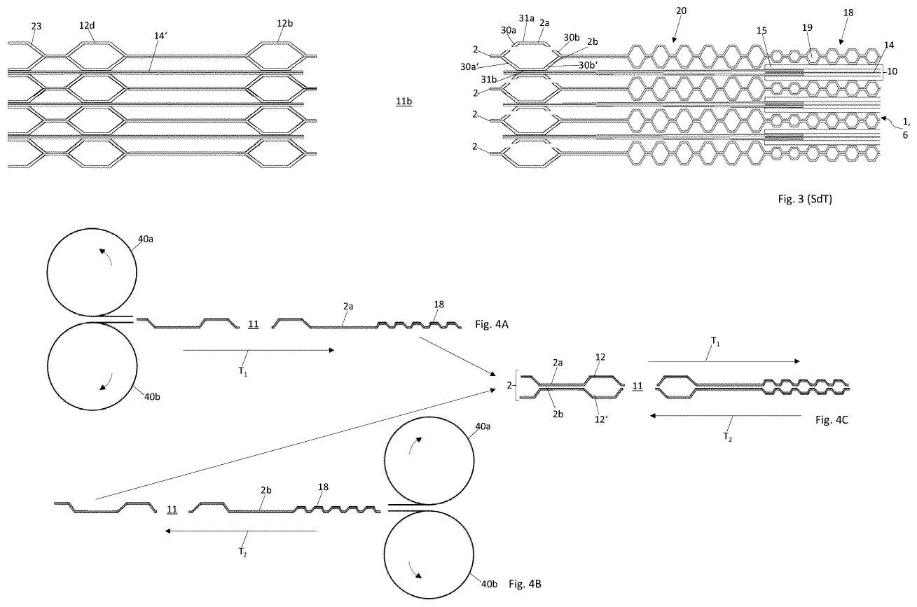

FIG. 1 shows an electrochemical system 1 comprising a plurality of structurally identical separator plates 2 (also referred to below as bipolar plates 2). The bipolar plates 2 are arranged in a stack 6 and are stacked in a z-direction 7. The bipolar plates 2 of the stack 6 are clamped between two end plates 3, 4. The z-direction 7 will also be referred to as the stacking direction. In this example, the system 1 is a fuel cell stack. Each two adjacent bipolar plates 2 of the stack thus enclose between them an electrochemical cell, which is used, for example, to convert chemical energy into electrical energy. To form the electrochemical cells of the system 1, a membrane electrode assembly (MEA) is arranged between each adjacent bipolar plate 2 of the stack (see e.g. FIG. 2). The MEAs typically each contain one membrane, e.g. an electrolyte membrane. Furthermore, a gas diffusion layer (GDL) may be arranged on one or both surfaces of the MEA.

Alternatively, the system 1 shown in FIGS. 1 and 2 may also be in the form of an electrolyzer, an electrochemical compressor, or a redox flow battery. Bipolar plates can likewise be used in these electrochemical systems. The structure of these bipolar plates may then correspond to the structure of the bipolar plates 2 explained in detail here, even though the media conducted on and/or through the bipolar plates in the case of an electrolyzer, an electrochemical compressor or a redox flow battery may differ in each case from the media used for a fuel cell system. For example, in an electrolyzer the separator plates need not necessarily be cooled separately. The corresponding supply lines and passages for a coolant, for example the ports 5′ in the end plate 4 and the through-openings 11a (to be made later) in the separator plates, including the associated separate sealing elements and lines, can then also be omitted. If a specific coolant is not needed, it is also possible to use single-layer separator plates instead of bipolar plates.

The z-axis 7, together with an x-axis 8 and a y-axis 9, spans a right-handed Cartesian coordinate system. The bipolar plates 2 each define a plate plane E in which the metal layers forming that plane are in contact with each other. In addition, in their non-reshaped regions the metal layers form their own plate plane, the plate planes of both the bipolar plates and the metal layers each being oriented in parallel with the x-y plane and thus perpendicularly to the stacking direction or to the z-axis 7. The end plate 4 has a multiplicity of media ports 5, 5′, via which media can be fed to the system 1 and via which media can be carried out of the system 1. Said media that can be fed to the system 1 and carried out of the system 1 may include, for example, fuels such as molecular hydrogen or methanol, reaction gases such as air or oxygen, reaction products such as water vapor or depleted fuels, or, where applicable, coolants such as water and/or glycol.

FIG. 2 is a perspective view of two adjacent bipolar plates 2, known from the prior art, of an electrochemical system of the type of system 1 from FIG. 1, and of a membrane electrode assembly (MEA) 10 known from the prior art arranged between said adjacent bipolar plates 2, the MEA 10 in FIG. 2 being largely obscured by the bipolar plate 2 facing towards the viewer. The bipolar plate 2 is formed of two metal layers 2a, 2b which are joined together in a materially bonded manner, of which in each case only the first metal layer 2a facing towards the viewer is visible in FIG. 2, said first metal layer obscuring the second metal layer 2b. The metal layers 2a, 2b can each be produced from a metal sheet, e.g. from a stainless-steel sheet or a sheet made of a titanium alloy. In this case, the sheets can be coated or plated in some portions or in their entirety, for example by means of an anti-corrosion and/or conductivity-promoting coat. The metal layers 2a, 2b can be interconnected in a materially bonded manner, for example welded, soldered or glued, such as connected using laser welds. In this view, adjacent bipolar plates 2 each delimit an electrochemical cell; in this case, therefore, the MEA is also construed as a cell.

The metal layers 2a, 2b have aligned through-openings, which form through-openings 11a-c in the bipolar plate 2. When a plurality of bipolar plates of the same type as the bipolar plate 2 are stacked, the through-openings 11a-c, together with aligned through-openings in the reinforcement edges of the MEAs, form lines which extend through the stack 6 in the stacking direction 7 (see FIG. 1). Typically, each of the lines formed by the through-openings 11a-c is in fluid communication with one of the ports 5, 5′ in the end plate 4 of the system 1. Via the lines formed by the through-openings 11a, coolant, for example, can be conveyed into the stack or conveyed out of the stack. In contrast, the lines formed by the through-openings 11b, 11c may be configured to supply fuel and reaction gas to the electrochemical cells of the fuel cell stack 6 of the system 1 and to conduct the reaction products out of the stack. The media-conducting through-openings 11a-11c are each oriented substantially in parallel with the plate plane. The aligned through-openings of the successive bipolar plates of a stack together form a line in the direction substantially perpendicular to the plate plane.

In order to seal the through-openings 11a-c with respect to the interior of the stack 6 and with respect to the surroundings, the first metal layers 2a each have sealing arrangements in the form of sealing beads 12a-c, which are respectively arranged around the through-openings 11a-c and in each case completely enclose the through-openings 11a-c. On the rear side of the bipolar plates 2, facing away from the viewer of FIG. 2, the second metal layers 2b have corresponding sealing beads for sealing the through-openings 11a-c (not shown).

In an electrochemically active region 18, the first metal layers 2a have, on their front facing towards the viewer of FIG. 2, a flow field 17 having structures (channels and ridges) 16 for conducting a reaction medium along the front of the metal layer 2a. In FIG. 2, these structures are provided by a multiplicity of ridges and by channels that extend between the ridges and are delimited by the ridges. On the front of the bipolar plates 2, facing towards the viewer of FIG. 2, the first metal layers 2a additionally each have at least one distribution or collection region 20. The distribution or collection region 20 comprises structures that are configured to distribute, over the active region 18, a medium that has been conveyed into the distribution or collection region 20 from a first of the two through-openings 11b and/or to collect or pool a medium flowing from the active region 18 towards the second of the through-openings 11b. In FIG. 2, the distribution structures of the distribution or collection region 20 are likewise provided by ridges and by channels that extend between the ridges and are delimited by the ridges. In general, the elements 17, 18, 20 can thus be understood as media-conveying embossed structures.

The sealing beads 12a-12c have passages 13a-13c, of which the passages 13a are formed both on the underside of the upper metal layer 2a and on the upper side of the lower metal layer 2b, while the passages 13b are formed in the upper metal layer 2a and the passages 13c are formed in the lower metal layer 2b. By way of example, the passages 13a allow coolant to pass between the through-opening 12a and the distribution region such that the coolant reaches the distribution region between the metal layers and is conducted out of it. In addition, the pas sages 13b allow hydrogen to pass between the through-opening 12b and the distribution region on the upper side of the upper metal layer 2a. Said passages 13b are typified by perforations, facing the distribution region and extending obliquely to the plate plane, in a collection channel 43 connected to the sealing bead and in which said passages end. Therefore, hydrogen, for example, flows through the passages 13b from the through-opening 12b to the distribution region on the upper side of the upper metal layer 2a or in the opposite direction. The passages 13c allow air, for example, to pass between the through-opening 12c and the distribution region, such that air reaches the distribution region on the underside of the lower metal layer 2b and is conducted out of said distribution region. The associated perforations are not visible here.

The first metal layers 2a each further have an additional sealing arrangement in the form of a peripheral bead 12d, which wraps around the flow field 17 of the active region 18, the distribution or collection region 20 and the through-openings 11b, 11c, and seals these with respect to the through-opening 11a, e.g. with respect to the coolant circuit, and with respect to the surroundings of the system 1. The second metal layers 2b each comprise corresponding peripheral beads 12d. In alternative plate designs, the peripheral bead can also include the coolant openings and thus the entire coolant circuit. The structures 16 of the active region 18, the distribution structures of the distribution or collection region 20 and the sealing beads 12a-d are each formed in one piece with the metal layers 2a and molded into the metal layers 2a, e.g. in an embossing, deep-drawing or hydroforming process. According to the present disclosure, at least one, several or all of the sealing beads 12a-d are molded into the metal layers 2a by roller embossing. The same applies to the corresponding distribution structures and sealing beads of the second metal layers 2b. For instance, the metal layers 2a and 2b can be shaped in their entirety by roller embossing. Outside the region surrounded by the peripheral bead 12d, an outer-edge region 22 in which no channels are arranged is produced in each metal layer 2a, 2b. The outer-edge region 22 is often flat and extends substantially in parallel with the plate plane of each metal layer 2a, 2b, but it can have a stepped embossing 23 in its outermost region directly adjacent to the outer edge 24.

The two through-openings 11b, or the lines through the plate stack of the system 1 that are formed by the through-openings 11b, are each in fluid communication with one another via passages 13b in the sealing beads 12b, via the distribution structures of the distribution or collection region 20 and via the flow field 17 in the active region 18 of the first metal layers 2a facing towards the viewer of FIG. 2. Analogously, the two through-openings 11c, or the lines through the plate stack of the system 1 that are formed by the through-openings 11c, are each in fluid communication with one another via corresponding bead passages, via corresponding distribution structures and via a corresponding flow field on an outer face of the second metal layers 2b facing away from the viewer of FIG. 2. In contrast, the through-openings 11a, or the lines through the plate stack of the system 1 that are formed by the through-openings 11a, are each in fluid communication with one another via a cavity 19 which is encompassed or enclosed by the metal layers 2a, 2b. Each cavity 19 serves to guide a coolant through the bipolar plate 2, such as to cool the electrochemically active region 18 of the bipolar plate 2.

In the case of a fuel cell, for example, the metal layers 2a, 2b of the bipolar plate 2 can each be formed, for example, from a stainless-steel sheet having a thickness of less than 100 μm. In the case of an electrolyzer, it is possible to use sheets made of a titanium alloy and also sheets made of fully coated stainless steel. The sheet thicknesses are usually greater in electrolyzers; for example, they can be 100-800 μm, 150-500 μm, or 200-300 μm. In general, the bipolar plate 2 has a substantially rectangular shape, but it can also be round or oval, such as in electrolyzers.

FIG. 3 shows a cross section through four bipolar plates 2 arranged one above the other in the stacking direction 7. A membrane electrode assembly 10 is arranged between each bipolar plate 2. The MEA 10 has three layers in the active region 18. A membrane 14 that is permeable to protons is arranged in the middle. A gas diffusion layer 15 is arranged on either side of the membrane 14. The electrodes connected to the membrane or the catalyst layer have not been illustrated. Outside the active region 18, the MEA consists of a two-layer reinforcement edge 14′, which, in fuel cells, usually consists of a thin polymer-based material and surrounds the active region 18. The segment in FIG. 3 surrounds the through-opening 11b for a reaction gas, but on the left-hand side it reaches as far as the outer edge 24.

The construction of the bipolar plate 2 will be explained using the example of the uppermost bipolar plate in the figure. It is identical for the subsequent bipolar plates.

The bipolar plate 2 has two metal layers 2a and 2b arranged adjacent to one another. They each have a sealing bead 12a and 12a′ surrounding the through-opening, said sealing beads being formed as full beads and surrounding the through-opening 11b circumferentially in an integrally closed manner. The full beads have bead flanks 30a, 30a′, 30b, 30b′, which merge into bead bottoms 32a, 32a′, 32b, 32b′. Bead tops 31a and 31b are located between the bead flanks 30a and 30b and between the bead flanks 30a′ and 30b′. The bead tops 31a and 31b of the beads 12a and 12a′ face away from one another.

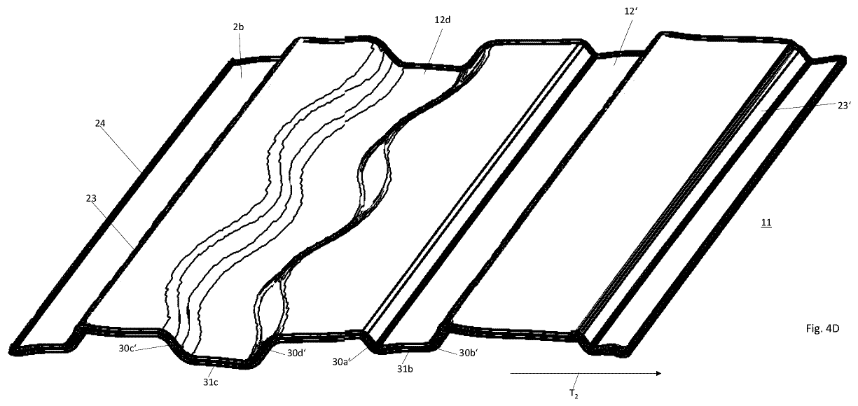

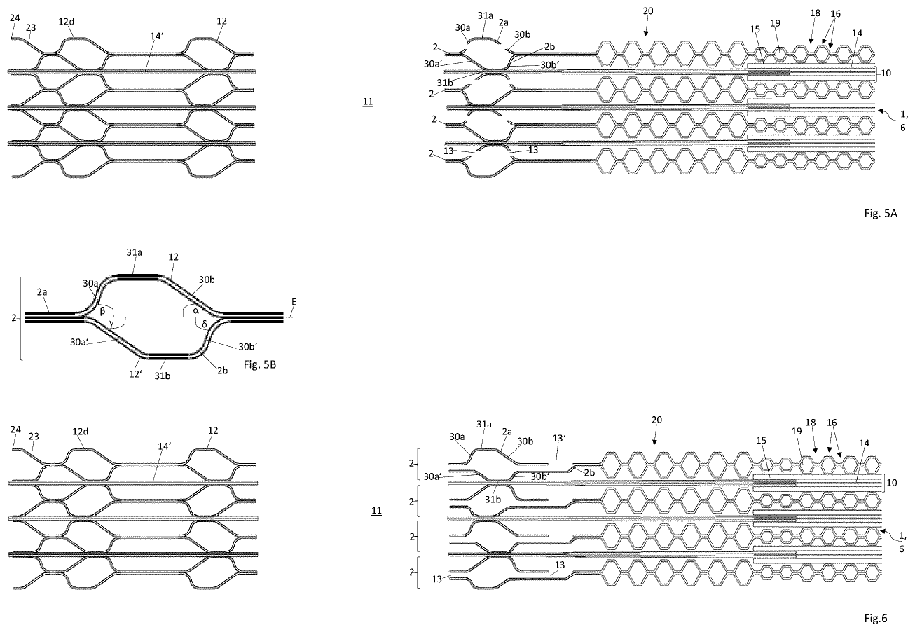

In the sub-figures 4A-4C, FIG. 4 shows a procedure of a roller embossing method for metal layers 2a and 2b and their assembly to form the bipolar plate 2 according to the present disclosure. In this case, like in the subsequent FIG. 5-10, a through-opening 11, a sealing bead 12 surrounding it in the first metal layer 2a, and a sealing bead 12′ in the second metal layer 2b around a through-opening are observed neutrally. Regardless of which reference numeral it is specifically assigned, said through-opening, for which reference numeral 11 is often used below, thus can be or represent each of the aforementioned through-openings 11a to 11c.

FIG. 4A shows the roller embossing of the layer 2a using two embossing rollers 40a and 40b. In the drawings, the transportation direction T₁ of the layer 2a through the embossing rollers 40a and 40b is from left to right in accordance with the directions of rotation specified in the figure for the embossing rollers 40a and 40b. In other words, the layer 2a is embossed in the direction of the through-opening 11 starting at the side of the active region 18.

FIG. 4B shows the roller embossing of the layer 2b using the same embossing rollers 40a and 40b. In the drawings, the transportation direction T₂ of the layer 2b through the embossing rollers 40a and 40b is from right to left in accordance with the directions of rotation specified in the figure for the embossing rollers 40a and 40b. In other words, the layer 2b is embossed in the direction of the active region starting at the side of the through-opening 11. Before being assembled with the layer 2a, the layer 2b is turned over again.

FIG. 4C shows the assembly of the two layers 2a and 2b to form the separator plate/bipolar plate 2. FIG. 4A to 4C each show only a segment of the metal layers 2a, 2b and of the bipolar plate 2.

FIG. 4D shows a cross section through a portion of a metal layer 2b from an outer edge 24 of the layer as far as a through-opening 11, cutting in the process through an embossing 23 adjacent to the outer edge, an undulating bead 12d similar to a peripheral bead, a bead 12′ extending in a straight line in the portion shown, and an embossing 23′ adjacent to the edge of the through-opening 11. By contrast with FIG. 4B, the transportation direction T₂ in this case points from the outer edge towards the through-opening 11, e.g. the peripheral bead 12d has been embossed before the bead 12′. In the undulating bead 12d, the flank on the entry side (right) is flatter than on the exit side (left), as can also be seen in the straight bead 12′.

FIG. 5A shows a stack of bipolar plates 2 similar to those in FIG. 3. Unlike the stack in FIG. 3, each of the bipolar plates is produced as shown in FIG. 4A-C. Owing to the roller embossing of the layers 2a and 2b, in the layer 2a the bead flanks 30a and 30b have a different tilt angle in relation to the plane of contact E between the layers 2a and 2b, as shown for example in FIG. 5B. Likewise, in the layer 2b the bead flanks 30a′ and 30b′ have a different tilt angle, again in relation to the plane of contact E between the layers 2a, 2b. The differences in the tilt angles are shown in a highly exaggerated manner in FIG. 5B. In reality, the differences are often ≤5°, in some cases ≤2.5°, in this case for example ≤1.5°.

With the rollers 40a and 40b as the embossing die configured in the same way, the different tilt angles of the bead flanks 30a and 30b result from the transportation direction of the layer 2a through the rollers 40a and 40b. The entry angle α produced in the bead flank 30b is smaller than the exit angle β produced in the bead flank 30a.

This also applies to the layer 2b, although it has been transported in the opposite direction for the roller embossing. As a result, the entry angle γ is smaller than the exit angle δ.

By arranging the bead flanks having the entry angle α of the bead 12 with the exit angle δ of the bead 12′ in a row, and by arranging the bead flanks having the exit angle β with the entry angle γ in a row, the two sides of the beads 12 and 12′ have a similar shape, similar spring behavior and similar rigidity. As a result, the sealing behavior of the sealing beads 12 and 12′ is greatly improved.

The bead tops 31a and 31b in FIG. 5 are flat when the bipolar plate 2 is in the non-compressed state.

FIG. 5a also shows bead passages 13 formed directly in the bead flanks of the first metal layer 2a.

The detailed view in FIG. 5B is cut through the segment of the stack 6 or separator plate 2 adjacent to the bead passages 13.

FIG. 6 shows an embodiment that has a different configuration compared with FIG. 5A as regards the bead passages 13; in this case, the beads of the layer 2b are formed without directly adjacent bead bottoms in some portions. Instead, a spacing from the bead bottoms of the upper layer 2a is created, spanning a flow space together with the openings 13′. However, this embodiment again has a cross section as in FIG. 5B between the bead passages (cf. FIG. 2).

Using the example in FIG. 7, but also in the subsequent figures, it is explained that the flank angle may be determined such that a tangent is placed at half the height of each bead 12, 12′ in a metal layer 2a, 2b and the angle thereof to the plane of contact E between the two layers 2a, 2b is determined.

FIG. 7A shows a further example of a portion of a stack 6 of bipolar plates 2 similar to that in FIG. 5. By contrast with FIG. 5, however, the bead tops 31a and 31b are now not flat in the non-compressed state of FIGS. 7A and 7B. Instead, the bead top 31a and also the bead top 31b bulge outwards in a convex manner.

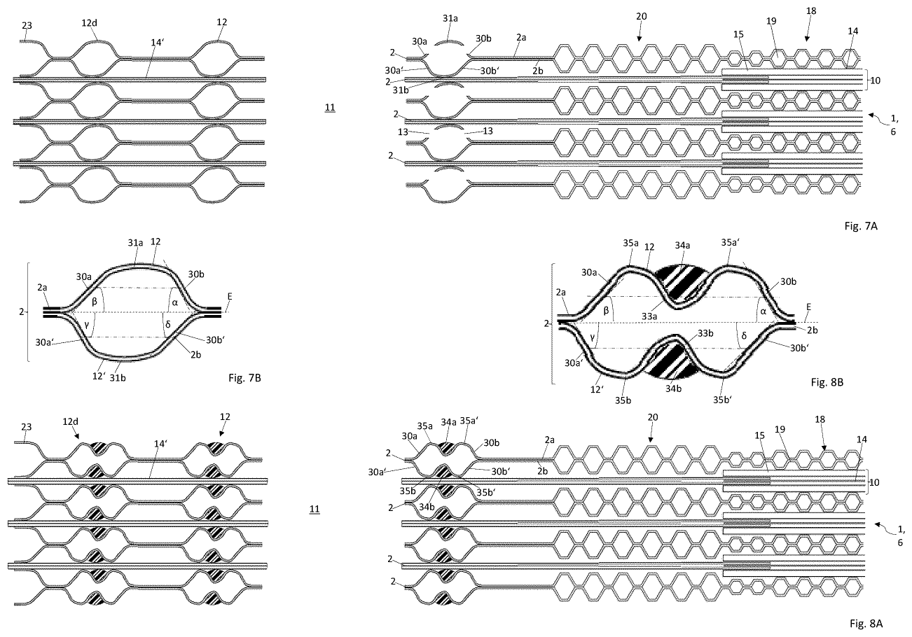

FIG. 8 shows a further example of a portion of a stack 6 of bipolar plates 2 similar to that in FIG. 5. By contrast with FIG. 5, the bead tops 31a and 31b are not flat in the non-compressed state of FIG. 8B, as is already the case in FIG. 7. Instead, the bead top 31a and also the bead top 31b bulge very far inwards in a concave manner. The resulting depressions 33a in the bead 12 and 33b in the bead 12′ are filled with an elastomeric sealant that extends substantially up to the height of the adjacent portions 35a and 35a′ of the bead top 31a and up to the height of the adjacent portions 35b and 35b′ of the bead top 31b. This elastomer bulge 34a and 34b serves to further enhance the sealing brought about by the sealing beads 12 and 12′, respectively.

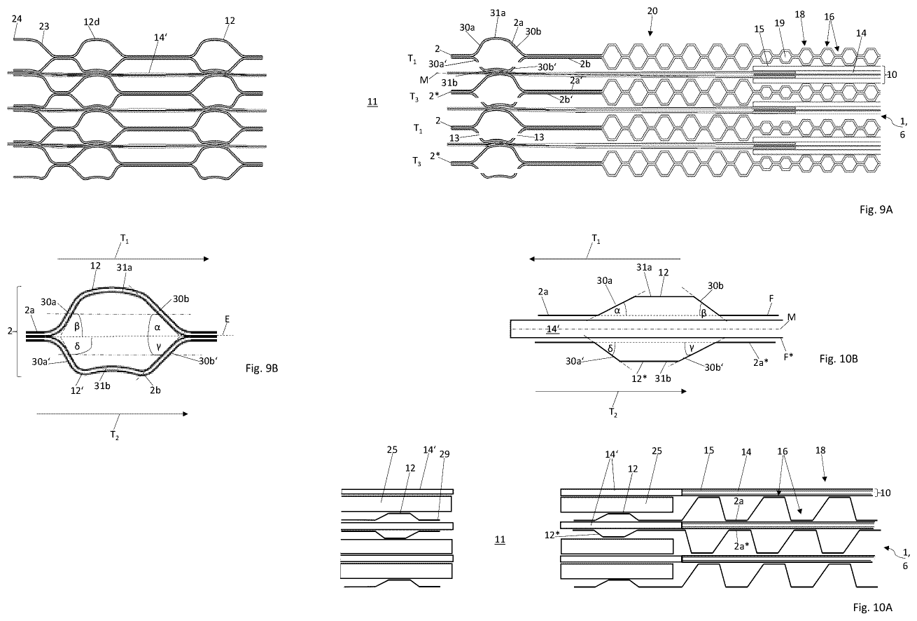

In sub-figures 9A and 9B, FIG. 9 shows a further example of a portion of a stack 6 consisting of bipolar plates 2 similar to that in FIG. 5. Bead passages 13 are shown again in sub-FIG. 9A, but now in the second metal layer 2b. The section in sub-figure 9B is at a point not crossed by any bead passage. In this case too, however, the bead tops 31a and 31b are not flat in the non-compressed state of FIG. 9B. Instead, the bead top 31a bulges outwards in a convex manner and the bead top 31b bulges inwards in a concave manner. FIG. 9 shows an embodiment example of the first variant of the present disclosure. As in the preceding embodiment examples, a membrane electrode assembly 10 is arranged between the first two-layer separator plate 2 and the second two-layer separator plate 2*. In each of said separator plates, an active region 18 is present, having in each case at least one set of embossed flow channels for a reaction medium along each surface of the separator plate 2, 2* adjacent to the membrane electrode assembly 10, as well as at least one first through-opening 11 for supplying a reaction medium to one of the sets of flow channels. In both layers 2a, 2b, the first through-opening 11 is formed identically in both layers 2a, 2b and enclosed by a roller-embossed sealing bead 12. In the mutually facing layers of the first and the second separator plate 2, 2*, said roller-embossed sealing beads 12 are arranged one above the other in the vertical direction in relation to the extension plane (neutral axis) M of the membrane electrode assembly 10. To homogenize the elasticity of the sealing elements, the roller-embossed sealing beads in the mutually facing layers of the first and the second separator plate are arranged such as to have different orientations. In this case, the first of these layers is roller-embossed in a first transportation direction T₁ and the second of these layers is roller-embossed in a different transportation direction T₃, which in this case is the opposite direction to T₁, the metal layers 2b, 2a′ being arranged the opposite way to one another in terms of their transportation directions. In the segment shown, the second through-opening for conducting the reaction medium away is not visible but its construction substantially matches that of the first through-opening 11.

Unlike in FIG. 5, in this case, within a separator plate 2, bead flanks having planar entry angles α, γ on the one hand and bead flanks having steeper exit angles β, δ on the other hand are arranged in a row. In the separator plates 2*, which alternate with the separator plates 2, exit angles β, δ are arranged within the row in which, in the separator plate 2, the entry angles α, γ form part of a complete spring assembly close to the through-opening. Entry angles α, γ are formed in the separator plate 2* in the row in which, in the separator plate 2, the exit angles β, δ form part of a complete spring assembly further away from the through-opening. In this case too, therefore, adjacent bead flanks are roller-embossed in different transportation directions even if they are separated indirectly by means of the reinforcement edge 14′ of the membrane electrode assembly 10.

FIG. 10 shows a cross section through a segment of a stack 6 of separator plates 2 and cells 10, as used such as in electrolyzers. In this arrangement, the two separator plates 2a, 2a* are single-layered, by contrast with the above examples. In this case too, both the structures 16 of the active region 18 and the sealing beads 12, 12* enclosing the through-opening 11 in each separator plate are molded using roller embossing. In addition, the segment of the stack shows cell frames 25, which terminate the active region towards the through-opening 11 together with the sealing beads 12, 12*. Between each two separator plates 2a, 2a*, there is arranged a membrane electrode assembly 10 having a diffusion medium 15 on either side next to the membrane 14; both are encompassed by a reinforcement edge 14′ towards the through-opening or towards the outer edge of the stack. Like in the preceding embodiment example, the roller-embossed sealing beads in the first and the second separator plate 2a, 2a*, e.g. on either side of the membrane electrode assembly 10, have different orientations. In this case, the first separator plate is roller-embossed in a first transportation direction T₁ and the second separator plate is roller-embossed in a second transportation direction T₂, and said two separator plates are arranged the opposite way to one another in terms of their transportation directions. In principle, the arrangement also has a second through-opening for conducting the reaction medium away from the set of flow channels, although it is not visible in the segment shown. In FIG. 10B, like in FIG. 5B, the bead flank having the entry angle α of the bead 12 and the bead flank having the exit angle δ of the bead 12* are arranged together in a row (albeit in this case indirectly, namely by the MEA reinforcement edge 14′); likewise, the bead flank having the exit angle β is arranged in a row with the bead flank having the entry angle γ, with the MEA reinforcement edge 14′ therebetween. The configuration of the bead flanks has point-symmetry in this arrangement too. By arranging the separator plates 2, 2* in an alternating manner in terms of the roller embossing direction, the sealing behavior of the sealing beads 12 and 12* is greatly enhanced, and the long-term reliable sealing of the stack 6 is ensured.

FIGS. 1-10B are shown approximately to scale. FIGS. 1-10B show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” or “substantially” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method of producing a separator plate for an electrochemical system, the method comprising:
roller embossing a first metal layer in a first transportation direction and roller embossing a second metal layer in a second transportation direction, and arranging the two layers opposite to one another relative to the respective transportation directions,
rolling embossing flow channels of an active region,
rolling embossing sealing beads,
the separator plate comprising:
the first metal layer and the second metal layer arranged adjacent to the first metal layer vertically in relation to the layer plane,
the active region having in each case at least one set of the roller-embossed flow channels for a reaction medium along each outer face of the separator plate, and
at least one first through-opening for supplying a reaction medium to one of the sets of flow channels, and one second through-opening for conducting the reaction medium away from the set of flow channels,
wherein at least the first through-opening in each of the metal layers or the second through-opening in each of the metal layers is enclosed by one of the roller-embossed sealing beads,
wherein the two roller-embossed sealing beads are arranged one above the other in the vertical direction in relation to a plane of contact between the first and the second metal layer and have different orientations.

2. The method according to claim 1, wherein the roller embossed beads of the first and the second layer are formed as full beads having a bead top, bead bottoms adjacent to the bead top, and bead flanks extending between the bead top and one of the bead bottoms in each case.

3. The method according to claim 2, wherein the beat tops or the bead bottoms of the roller-embossed beads of the first and the second layer either face one another or face away from one another.

4. The method according to claim 3, wherein at least one of the full beads has, at least in some portions in cross section transversely to the extension direction of the full bead, a bead top that is straight or curved and a recess in the direction of the plane of the bead bottoms between the adjacent bead flanks.

5. The method according to claim 4, wherein an elastomer is arranged at least in some portions in the recess in the direction of the extension of the roller-embossed bead and/or transversely to the direction of the extension of the roller-embossed bead.

6. The method according to claim 1, wherein, along the extension of the roller-embossed beads, at least in the regions in which the roller-embossed beads are either facing one another or facing away from one another by their bead tops, bead flanks of the roller-embossed bead of the first layer and bead flanks of the roller-embossed bead of the second layer that are directly adjacent to one another have different flank angles at least in some portions.

7. The method according to claim 6, wherein, along the extension of the roller-embossed beads, at least in the regions in which the roller-embossed beads are facing one another or in which the roller-embossed beads are facing away from one another, the beads facing one another or facing away from one another together have, at least in some portions, a substantially point-symmetrical cross section transversely to the extension direction of the first bead and the second bead.

8. The method according to claim 1, wherein, the transportation direction for at least one out of the first layer and the second layer extends, at least in some portions, substantially perpendicularly to or substantially in parallel with the longitudinal extension of at least one of the sets of flow channels for a reaction medium of the respective layer.

9. The method according to claim 1, wherein at least one set of flow channels for a reaction medium of the first layer has first grooves and adjacent first ridges, wherein the first grooves form the base of the flow channels for a reaction medium and the first ridges form the walls thereof, and at least one set of flow channels for a reaction medium of the second layer has second grooves and adjacent second ridges, wherein the second grooves form the base of flow channels for a reaction medium and the second ridges form the walls thereof.

10. The method according to claim 9, wherein the flow channels of at least one set of flow channels for a reaction medium parallel to the layer plane of the first layer and/or the second layer extend in a straight, wave-shaped, zigzag or meandering manner.

11. The method according to claim 10, wherein, in a cross section through flow channels for a reaction medium, first ridges and second ridges are arranged in pairs opposite one another at least at some points or in some portions, and first grooves of the first layer, which are adjacent to the first ridges, and second grooves of the second layer, which are adjacent to the second ridges, are both arranged with the backs of their groove bases adjacent to one another at least at some points or in some portions.

12. A method for producing an electrochemical system comprising a first separator plate and a second separator plate and a membrane electrode assembly arranged between the two separator plates, the method comprising:
roller embossing a first metal layer in a first transportation direction and roller embossing a second metal layer in a second transportation direction, and arranging the two layers opposite to one another relative to the respective transportation directions,
roller embossing flow channels of an active region,
rolling embossing sealing beads,
the separator plates each comprising:
the first metal layer and a second metal layer arranged adjacent to the first metal layer vertically in relation to the layer plane,
an active region having at least one set of the roller-embossed flow channels for a reaction medium along each outer face of the separator plate, and
at least one first through-opening for supplying a reaction medium to one of the sets of flow channels, and one second through-opening for conducting the reaction medium away from the set of flow channels,
wherein, in each of the two separator plates, at least the first through-opening in each of the metal layers or the second through-opening in each of the metal layers is enclosed by one of the roller-embossed sealing beads,
wherein the roller-embossed sealing beads in the mutually facing layers of the first and the second separator plate are arranged one above the other in the vertical direction in relation to the extension plane of the membrane electrode assembly,
wherein
the roller-embossed sealing beads in the mutually facing layers of the first and the second separator plate have different orientations.

13. A method of producing an arrangement for an electrochemical system comprising a first separator plate and a second separator plate each having a metal layer, and a membrane electrode assembly arranged between the two separator plates, wherein at least one of said separator plates has exactly one metal layer, the method comprising:
roller embossing a first metal layer in a first transportation direction and roller embossing a second metal layer in a second transportation direction, and arranging the two layers opposite to one another relative to the respective transportation directions,
rolling embossing flow channels of an active region,
rolling embossing sealing beads,
the separator plates each comprising:
the active region having in each case at least one set of the roller-embossed flow channels for a reaction medium along each outer face of the separator plate, and
at least one first through-opening for supplying a reaction medium to one of the sets of flow channels, and one second through-opening for conducting the reaction medium away from the set of flow channels,
wherein, in each of the two separator plates, at least the first through-opening is enclosed by one of the roller-embossed sealing beads,
wherein the roller-embossed sealing beads in the first and the second separator plate are arranged one above the other in the vertical direction in relation to the extension plane of the membrane electrode assembly,
wherein the roller-embossed sealing beads in the first and the second separator plate have different orientations,
wherein the first separator plate is roller-embossed in a first transportation direction and the second separator plate is roller-embossed in a second transportation direction, and said two separator plates are arranged the opposite way to one another in terms of their transportation directions.

14. A fuel cell or electrolyzer comprising a stack of separator plates produced according to the method of claim 1, wherein the separator plates are arranged adjacent to one another, or comprising a stack of arrangements arranged adjacent to one another.
